(19) United States
(12) Patent Application Publication
(10) Pub. No.: US 2013/0123966 A1
(43) Pub. Date: May 16, 2013

(54) SPATIAL THREE-DIMENSIONAL INLINE HANDLING SYSTEM

(71) Applicant: Yun Wang, Shenzhen (CN)

(72) Inventor: Yun Wang, Shenzhen (CN)

(73) Assignee: Shenzhen China Star Optoelectronics Technology Co., Ltd., Shenzhen, Guangdong (CN)

(21) Appl. No.: 13/377,533

(22) PCT Filed: Nov. 15, 2011
(86) PCT No.: PCT/CN2011/082243

§ 371 Date: Dec. 9, 2011

(30) Foreign Application Priority Data
Nov. 14, 2011 (CN) 201110358559.8

(51) Int. Cl. G06F 19/00

(52) U.S. Cl. 700/112; 901/31

(57) ABSTRACT

A spatial three-dimensional (3D) inline handling system comprises: a ceiling with guide rails; a plurality of cassettes disposed at a bottom surface of the ceiling to temporarily store substrates; a plurality of processing units disposed below the cassettes to process the substrates; and an overhead handling apparatus for handling the substrates between the cassettes and the processing units and slidably connected with the guide rails. In the present disclosure, the ground space occupied by the handling system is reduced by adopting a 3D handling manner and disposing robot arms at overhead positions, and the space utilization factor is greatly increased by disposing the processing units of the substrate processing line concentratively. Meanwhile, the robot arms handles the substrates overhead to improve the handling efficiency; furthermore, because the overhead handling apparatus is located near the FFUs, cleanliness of the substrates is increased and, consequently, the product yield is increased.

### BACKGROUND

1. Technical Field The present disclosure relates to the technical field of liquid crystal displays (LCDs), and more particularly, to a spatial three-dimensional (3D) inline handling system.

2. Description of Related Art

During the manufacturing process of LCD panels, robot arms are generally disposed at the ground in inline facilities to handle and load glass substrates.

As sizes of the LCD panels increase gradually, requirements on both the volume and the speed of the robot arms are increasingly heightened. Factors including the footprint, the turning radius, the driving shaft, the stroke and the handling capacity of the robot arms must be considered in design and assembly of the inline facilities. Take a common G8.5 One Drop Filling (ODF) processing line for example, generally 8-12 robot arms need to be disposed at the ground, which usually makes the line as long as about 120 m. Therefore, the conventional practice of disposing the robot arms at the ground consumes much ground space; and moreover, as it takes a long cycle time for the robot arms disposed at the ground to handle a glass substrate, the handling efficiency is poor.

### BRIEF SUMMARY

The primary objective of the present disclosure is to provide a spatial 3D inline handling system, which is intended to reduce the ground space occupied by the substrate handling system and improve the handling efficiency.

To achieve the aforesaid objective, the present disclosure provides a spatial 3D inline handling system, which comprises: a ceiling provided with guide rails; a plurality of cassettes disposed at a bottom surface of the ceiling to temporarily store substrates; a plurality of processing units disposed below the cassettes to process the substrates; and an overhead handling apparatus for handling the substrates between the cassettes and the processing units and slidably connected with the guide rails.

Preferably, the overhead handling apparatus comprises a mechanical grasper, a telescopic mechanism and a controller configured to control the mechanical grasper and the telescopic mechanism. The mechanical grasper has a central portion and a plurality of robot arms each having a claw and extending outwards from the central portion. The mechanical grasper is rotatably connected with a bottom end of the telescopic mechanism via the central portion, and a top end of the telescopic mechanism is slidably connected with the guide rails of the ceiling.

Preferably, the guide rays are disposed in a mesh form on the bottom surface of the ceiling.

Preferably, the telescopic mechanism is a telescopic shaft perpendicular to the bottom surface of the ceiling.

Preferably, the mechanical grasper comprises four said robot arms. The four robot arms are distributed symmetrically along a periphery of the central portion. The number of the processing units is four, and each of the processing units corresponds to one of the robot arms respectively.

Preferably, the processing units each have an opening for the claw of one of the robot arms to pick up the substrates.

Preferably, a rotation angle of the mechanical grasper is ±180°.

Preferably, the controller is a servo motor controller.

Preferably, the spatial 3D inline handling system further comprises fan filter units disposed on the ceiling and located beside the cassettes.

According to the spatial 3D inline handling system of the present disclosure, the ground space occupied by the handling system is reduced by adopting a 3D handling manner and disposing robot arms originally located at the ground at overhead positions, and the space utilization factor is greatly increased by disposing the processing units of the substrate processing line concentratively. Meanwhile, because no obstacle exists for the robot arms handling the substrates overhead, the handling efficiency is greatly improved; and furthermore, because the overhead handling apparatus is located near the FFUs, cleanliness of the substrates is increased and, consequently, the product yield is increased.

### BRIEF DESCRIPTION OF THE DRAWINGS

FIG. 1 is a perspective schematic view illustrating a structure of a preferred embodiment of a spatial 3D inline handling system according to the present disclosure.

Hereinafter, implementations, functional features and advantages of the present disclosure will be further described with reference to embodiments thereof and the attached drawings.

### DETAILED DESCRIPTION

The present disclosure will be described in detail hereinbelow with reference to the attached drawings and embodiments thereof. It shall be understood that, the embodiments described herein are only intended to illustrate but not to limit the present disclosure.

The solution of the embodiments of the present disclosure is primarily as follows: the ground space occupied by the handling system is reduced and the space utilization factor is increased by adopting a spatial 3D handling manner, disposing robot arms originally located at the ground at overhead positions and disposing the processing units of the processing line concentratively; and because no obstacle exists for the robot arms handling the substrates overhead, the handling efficiency can be greatly improved.

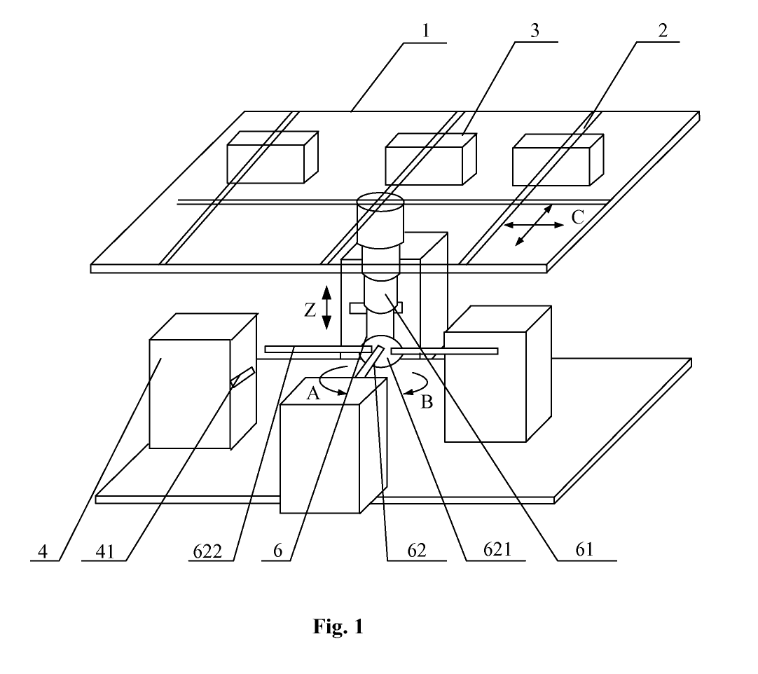

Referring to FIG. 1, there is shown a perspective schematic view illustrating a structure of a preferred embodiment of a spatial 3D inline handling system according to the present disclosure.

The spatial 3D inline handling system of this embodiment comprises: a ceiling 1 provided with guide rails 2; a plurality of cassettes 3 disposed at a bottom surface of the ceiling 1 to temporarily store substrates; a plurality of processing units 4 disposed below the cassettes 3 to process the substrates; and a telescopic overhead handling apparatus 6 for handling the substrates between the cassettes 3 and the processing units 4. The overhead handling apparatus 6 is slidably connected with the guide rails 2, and can move along the corresponding guide rails 2 on the bottom surface of the ceiling 1. The guide rails 2 are fixed to or suspended from the bottom surface of the ceiling 1, and are disposed in a mesh form on the bottom surface of the ceiling 1. The overhead handling apparatus 6 moves along the guide rails 2 in directions as shown by arrows at the position C in FIG. 1, i.e., moves between front and back and between left and right.

Specifically, in this embodiment, the overhead handling apparatus 6 comprises a mechanical grasper 62, a telescopic mechanism 61 and a controller (not shown) configured to control the mechanical grasper 62 and the telescopic mechanism 61. The mechanical grasper 62 has a central portion 621 and a plurality of robot arms 622 each having a claw (not shown) and extending outwards from the central portion 621. The mechanical grasper 62 is rotatably connected with a bottom end of the telescopic mechanism 61 via the central portion 621, and a top end of the telescopic mechanism 61 is slidably connected with the guide rails 2 of the ceiling 1.

In this embodiment, the telescopic mechanism 61 is a telescopic shaft perpendicular to the bottom surface of the ceiling 1 and extensible between top and bottom in directions shown by arrows at the position Z in FIG. 1. The top end of the telescopic shaft is slidably connected with the guide rails 2 on the bottom surface of the ceiling 1 so that the telescopic shaft can move to the corresponding cassettes 3 in the directions as shown by the arrows at the position C in FIG. 1.

The central portion 621 of the mechanical grasper 62 is rotatably connected with the bottom end of the telescopic shaft so that under the control of the aforesaid controller, the mechanical grasper 62 can rotate with respect to the telescopic shaft in a horizontal plane. A rotation angle of the mechanical grasper 62 may be set as ±180°, and rotation directions of the mechanical grasper 62 are as shown by the position A, B in FIG. 1.

The central portion 621 of the mechanical grasper 62 may be rotatably connected with the bottom end of the telescopic shaft through a bearing or other rotation structures.

In this embodiment, the mechanical grasper 62 comprises four robot arms 622. The four robot arms 622 are distributed symmetrically along a periphery of the central portion 621 of the mechanical grasper 62. The number of the corresponding processing units 4 is four, and each of the processing units 4 corresponds to one of the robot arms 622 respectively. The processing units 4 each are provided with an opening 41 for the claw of one of the robot arms 622 to pick up the substrates. And the claw of the robot arm 622 is similar to a human hand for picking up the substrates from the opening 41 of one of the processing units 4.

After the claw of the robot arm 622 picks up a substrate, the telescopic shaft drives the robot arm 622 to handle the substrate to a corresponding one of the cassettes 3 at the bottom surface of the ceiling 1.

It shall be appreciated that, there may be a plurality of processing units 4 and also a plurality of cassettes 3 for temporarily storing the substrates depending on the needs of the process. Depending on different substrate processing processes, the processing units 4 and the cassettes 3 may be classified in such a way that one, two or a plurality of processing units 4 may be used to process substrates in a same process and one, two or a plurality of cassettes 3 may be used to temporarily store the processed substrates in the same process.

When the substrate is processed by the processing unit 4 and is to be conveyed to the cassette 3 for temporary storage, the substrate in the corresponding processing unit 4 is handled by the overhead handling apparatus 6 to the corresponding cassette 3 for temporary storage.

In this embodiment, the four robot arms 622 can pick up the substrates from the four corresponding processing units 4 simultaneously, and then the substrates can be placed into the corresponding cassettes 3 by means of the telescopic shaft.

Furthermore, the processing units 4 may be placed on the ground or a machine; the processing units 4 may or may not have a one-to-one correspondence relationship with the robot arms 622; and the processing units 4 may be placed on the ground or the machine symmetrically or at arbitrary angles.

In this embodiment, the controller configured to control the mechanical grasper 62 and the telescopic mechanism 61 may be a servo motor controller.

Furthermore, in a preferred implementation, fan filter units (not shown) may be disposed beside the cassettes 3. Because of the function of purifying air, the fan filter units are favorable for improving cleanliness of the substrates during the handling process when the substrates are handled by the overhead handling apparatus 6 from the processing units 4 to the cassettes 3, which can further increase the substrate product yield.

When the substrates are handled, the overhead handling apparatus 6 may handle the substrates in the processing units 4 to the corresponding cassettes 3 for temporary storage or may pick up the substrates from the corresponding cassettes 3 and handle the substrates to the corresponding processing units 4 for processing depending on the needs of the processing line.

Specifically, the process for the overhead handling apparatus 6 to handle the substrates in the processing units 4 to the corresponding cassettes 3 for temporary storage is as follows.

When the overhead handling apparatus 6 is about to pick up the substrates from the processing units 4, the telescopic shaft of the overhead handling apparatus 6 is controlled by the controller to move (move between left and right or between front and back) from an initial position to an upside of a preset picking-up position via the guide rails 2 in the directions shown by the arrows at the position C in FIG. 1 and then move downward in the directions shown at the position Z in FIG. 1 to lower the mechanical grasper 62 to the picking-up position. Then, the robot arms 622 are controlled by the controller to pick up the substrates from the corresponding processing units 4.

When the picked-up substrates are about to be handled to the cassettes 3 located at the upper portion of the space for temporary storage, the telescopic shaft is controlled by the controller to contract upward; and at the same time, the telescopic shaft moves to the corresponding cassettes 3 along the predetermined guide rails 2. Then, the robot arms 622 place the picked-up substrates into the cassettes 3. In this way, the handling process of the substrates from the processing units 4 to the cassettes 3 is completed.

The handling process of the substrates from the cassettes 3 to the processing units 4 is reverse to the aforesaid process, and thus will not be further described herein.

In this embodiment, because the robot arms 622 each having four or more claws can pick up and place or handle four or more substrates at a time, the handling efficiency of the overhead handling apparatus 6 is greatly improved.

Meanwhile, according to this embodiment, the space utilization factor is greatly increased by concentrating the processing units 4 of the process and adopting a spatial 3D handling manner; because no obstacle exists, the handling efficiency of the substrates can be greatly improved by distributing the numbers of the guide rails 2 and the robot arms 622 reasonably; and because the driving shaft is omitted and the processing units 4 can be disposed concentratively, the ground space is greatly reduced and the factory space is decreased, which can greatly reduce the cost of investments in the preliminary stage of the factory.

Furthermore, because the substrates are handled overhead in this embodiment, the substrates are prevented from being affected by dust at the ground; and the FFUs disposed beside the cassettes 3 can greatly improve cleanliness of the substrates and further increase the product yield.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

1. A spatial three-dimensional (3D) inline handling system, comprising: a ceiling provided with guide rails; a plurality of cassettes disposed at a bottom surface of the ceiling to temporarily store substrates; a plurality of processing units disposed below the cassettes to process the substrates; and an overhead handling apparatus for handling the substrates between the cassettes and the processing units and slidably connected with the guide rails, wherein the guide rays are disposed in a mesh form on the bottom surface of the ceiling.

2. The spatial 3D inline handling system of claim 1, wherein the overhead handling apparatus comprises a mechanical grasper, a telescopic mechanism and a controller configured to control the mechanical grasper and the telescopic mechanism; the mechanical grasper has a central portion and a plurality of robot arms each having a claw and extending outwards from the central portion; and the mechanical grasper is rotatably connected with a bottom end of the telescopic mechanism via the central portion, and a top end of the telescopic mechanism is slidably connected with the guide rails of the ceiling.

3. The spatial 3D inline handling system of claim 2, wherein the telescopic mechanism is a telescopic shaft perpendicular to the bottom surface of the ceiling.

4. The spatial 3D inline handling system of claim 2, wherein the mechanical grasper comprises four said robot arms, the four robot arms are distributed symmetrically along a periphery of the central portion, the a number of the processing units is four, and each of the processing units corresponds to one of the robot arms respectively.

5. The spatial 3D inline handling system of claim 4, wherein the processing units each have an opening for the claw of one of the robot arms to pick up the substrates.

6. The spatial 3D inline handling system of claim 5, wherein a rotation angle of the mechanical grasper is ±180°.

7. The spatial 3D inline handling system of claim 2, wherein the controller is a servo motor controller.

8. The spatial 3D inline handling system of claim 1, further comprising fan filter units disposed on the ceiling and located beside the cassettes.

9-17. (canceled)
